(19) United States
(12) Patent Application Publication
(10) Pub. No.: US 2016/0319743 A1
(43) Pub. Date: Nov. 3, 2016

(54) BIRD GUARD DEVICE

(71) Applicant: James Thomas, Newark, NJ (US)

(72) Inventor: James Thomas, Newark, NJ (US)

(21) Appl. No.: 15/140,450

(22) Filed: Apr. 27, 2016

Related U.S. Application Data
(60) Provisional application No. 62/154,965, filed on Apr. 30, 2015.

(51) Int. Cl. F02C 7/055

(52) U.S. Cl. CPC F02C 7/055; F05D 2220/32; F05D 2230/60

(57) ABSTRACT

A bird guard device for protecting aircraft jet engines from being damaged from ingestion of birds during a bird strike is provided. The jet engine has an outer cowling with an open front end. The bird guard device comprises a mesh deflection screen capable of being mounted within the open front end of the outer cowling. The deflection screen minimizes the chance of birds getting into the jet engine.

### CLAIM OF PRIORITY

This patent application claims priority under 35 USC 119 (e) (1) from U.S. Provisional Patent Application Ser. No. 62/154,965 filed Apr. 30, 2015, of common inventorship herewith entitled, “Bird Guard,” which is incorporated herein by reference as though the same were set forth in its entirety.

### FIELD OF THE INVENTION

The present invention pertains to the field of aircraft jet engine protection and more specifically to the field of integrated protective guards for aircraft jet engine protection.

### BACKGROUND OF THE INVENTION

A bird strike is defined as a collision between a bird and an aircraft which is in flight or on a takeoff or landing. Bird strikes are common and significant threat to aircraft safety. For smaller aircrafts, significant damage can occur to the aircraft's structure. All jet engine aircrafts are vulnerable to the loss of thrust which follows an ingestion of birds into jet engine air intakes. Bird strikes put the lives of aircraft crew members and their passengers at risk and have resulted in a number of crashes with fatalities.

Bird strikes may occur during any phase of a flight but are most likely to occur during takeoff, initial climb, approach and landing phases due to the greater numbers of birds in flight at lower levels. Bird strikes have occurred at high altitudes, some as high as approximately twenty thousand to thirty thousand feet above the ground. Bar headed geese may fly as high as approximately thirty three thousand feet above sea level. Birds fly mainly during the day, so bird strikes usually occur in daylight hours. Most accidents occur when birds hit the windscreen or fly into the engines. These cause annual damages to commercial aircraft worldwide, estimated to costing well over one billion dollars each year.

The point of impact is usually any forward facing edge of the aircraft such as a wing leading edge, nose cone, jet engine cowling or engine inlet. Jet engine ingestion is extremely serious due to the rotation speed of the engine fan and engine design. As the bird strikes a fan blade, that blade can be displaced into another blade and so forth, causing a cascading failure. Jet engines are particularly vulnerable during the takeoff phase when the engine is turning at a very high speed and the plane is at a low altitude where birds are most commonly found.

The force of the impact on an aircraft depends on the weight of the animal and the speed difference and direction at the moment of impact. The energy of the impact increases with the square of the speed difference. A low speed impact of a small bird on a car windshield causes relatively little damage. High speed impacts, as with jet aircraft, can cause considerable damage and even catastrophic failure to the aircraft. Bird strikes have forced an average of one plane a day to land prematurely.

The prior art has put forth several designs for integrated protective guards. Among these are:

U.S. Pat. No. 6,138,950 to Barnaby Sam Wainfan, Yu Ping Liu, Daniel R. Rihn, Douglas William Legett, Martin James Geroges, Jeffry Scott Philhower, Douglas Ellwood Shultz and Charles Boccados describes an aircraft engine air intake cover for use with an air intake which is characterized by an air velocity profile there within. The air intake cover is provided with an air induction plate which disposes across at least a portion of the air intake. The air intake cover is further provided with a multitude of air induction ducts. The induction ducts are disposed about and extend through the air induction plate. Each induction duct has a duct inlet, a duct outlet and a duct body interposed between the duct inlet and the duct outlet. The duct inlets each respectively define an effective inlet diameter. The duct bodies each respectively define a duct body length which is greater than the associated effective duct inlet diameter. The duct outlets each respectively define an effective outlet diameter greater than the effective inlet diameter for increasing the cohesiveness of the air velocity profile within the air intake

U.S. Pat. No. 4,833,879 to Norbertus Verduyn and Gerard de Greef describes a turbo engine guard for mounting on the air inlet side of a turbo engine, particularly of airplanes. The guard comprises guard elements possessing an optimum aerodynamic design. The center lines or their extensions of the guard elements intersect or do not intersect each other in one plane. The guard elements are helically mounted, preferably along several helical lines. The guard elements are kept under a tension so these elements return to their original position after collision. Suitable materials for the guard elements are plastics of the poly p phenylene, terephtalamide type, carbon fibers, metal or parts being held together by a binder being resistant to temperatures comprised between one hundred fifty degrees centigrade and negative fifty degrees centigrade. If a guard element breaks in pieces, the resultant parts undergo an approximate shortening, preferably obtained by a spring force introduced into these parts, to a length being less than the distance between the rotating parts of the engine and the location at which this resultant part is kept in position. The resultant parts are also pulled away from the inflowing air stream by means of a member or construction mounted inside or outside the air inlet and inside or outside the element concerned. The guard is at least partially detachable or replaceable.

U.S. Pat. No. 2,931,460 to Benjamin McEachern Alexander describes a debris guard for an air intake duct that comprises means for permitting a flow of air in a direction axially of the duct. The guard impedes or prevents the passage of discrete bodies above a predetermined size in all directions downstream of the duct other than in a direction which is transverse to and inclined upwardly of a horizontal plane which includes the axis of the duct. The guard provides for an unobstructed passage of a flow of air in said direction which is transverse to and inclined upwardly to the horizontal plane.

None of these prior art references describe the present invention.

### SUMMARY OF THE INVENTION

It is an object of the present invention to provide a deflection screen that functions as an engine guard, protecting aircraft jet engines from being damaged from ingestion of birds during a bird strike.

The present invention is a bird guard device for protecting aircraft jet engines from being damaged from ingestion of birds during a bird strike. The jet engine has an outer cowling with an open front end. The bird guard device comprises a mesh deflection screen capable of being mounted within the open front end of the outer cowling. The deflection screen minimizes the chance of birds getting into the jet engine.

In addition, the present invention includes a method for protecting aircraft jet engines from being damaged from ingestion of birds during a bird strike. The jet engine has an outer cowling with an open front end. The method comprises mounting a mesh deflection screen within the open front end of the outer cowling, deflecting birds off the deflection screen, and minimizing the chance of birds getting into the jet engine.

The present invention further includes a bird guard device for protecting aircraft jet engines from being damaged from ingestion of birds during a bird strike. The jet engine has an outer cowling with an open front end. The bird guard device comprises a mesh deflection screen capable of being mounted within the open front end of the outer cowling. The deflection screen has a convex conical shape with the deflection screen completely covering the open front end of the outer cowling. The deflection screen minimizes the chance of birds getting into the jet engine.

### BRIEF DESCRIPTION OF THE DRAWINGS

FIG. 1 is an elevational front view illustrating a bird guard device, constructed in accordance with the present invention, showing a screen deflection guard installed in a jet engine.

FIG. 2 is a perspective side diagonal view illustrating the bird guard device, constructed in accordance with the present invention, showing the screen deflection guard installed in the jet engine.

FIG. 3 is a perspective diagonal view illustrating the bird guard device, constructed in accordance with the present invention, showing the screen deflection guard installed in the jet engine.

FIG. 4 is a sectional side view illustrating the bird guard device, constructed in accordance with the present invention, showing the screen deflection guard installed in the jet engine.

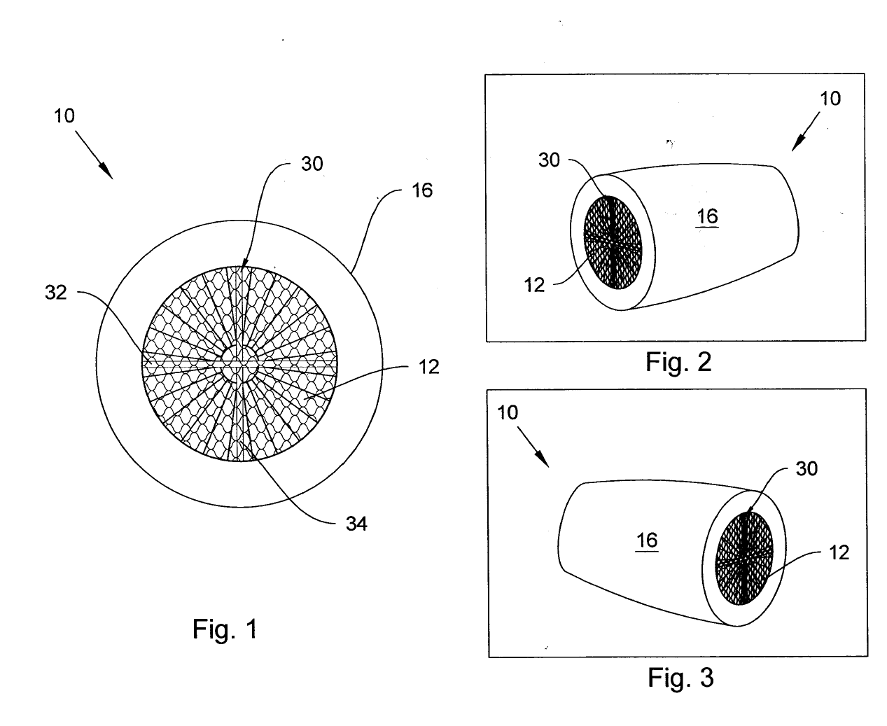

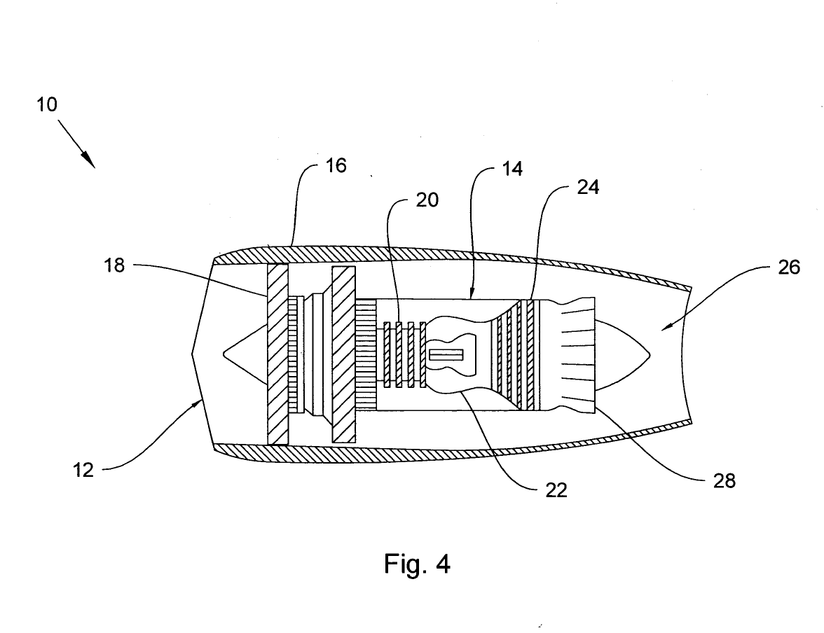

### DETAILED DESCRIPTION OF THE INVENTION

The present invention, hereinafter referred to as the Bird Guard Device, indicated generally at 10, is a screened guard device 12 for protecting aircraft jet engines 14 from being damaged from ingestion of birds during a bird strike. The jet engine 14 has an outer cowling 16 having an open front end and an open rear end with the outer cowling 16 enclosing the parts of the jet engine 14. Typically, the parts include a fan 18 rotatably positioned nearingly adjacent the open front end of the outer cowling 16, a compressor 20, a combustor 22, a turbine 24, and a mixer 28. A nozzle 26 is positioned at the open rear end of the jet engine 14. It should be noted that the listed parts of the jet engine 14 are merely an example of a jet engine 14 and for assistance in describing the present invention. As understood by those persons skilled in the art, the Bird Guard Device 10 can be used with any jet engine 14 and not limited by the jet engine description herein.

As stated, the Bird Guard Device 10 of the present invention is a mesh deflection screen 12 for minimizing the chance of birds getting into the jet engine 14 and causing great damage and potential loss of control of the aircraft with catastrophic consequences. Preferably, the deflection screen 12 is constructed from an aircraft grade aluminum or composite, although constructing the deflection screen 12 from other materials is within the scope of the present invention.

The Bird Guard Device 10 of the present invention comprises the mesh deflection screen 12 mounted nearingly adjacent the open front end of the cowling 16 between the open front end and the fan 18 of the jet engine 14. Preferably, the deflection screen 12 completely covers the open front end of the cowling 16, however, it is within the scope of the present invention for the deflection screen 12 to only cover a portion of the open front end of the cowling 16.

In a preferred embodiment, the deflection screen 12 of the Bird Guard Device 10 of the present invention is welded inside the cowling 16 just inside the open front end of the cowling 16. It is within the scope of the present invention, however, to secure the deflection screen 12 to the cowling 16 by other mechanical fastening means or to secure the deflection screen 12 to the cowling 16 outside the open front end of the cowling 16.

In addition, the deflection screen 12 of the Bird Guard Device 10 of the present invention further has a slight convex conical shape with an apex of the conical deflection screen 12 positioned beyond the open front end of the cowling 16. The conical shape of the deflection screen 12 adds strength to the deflection screen 12 to inhibit the deflection screen 12 from collapsing upon collision with a large bird or birds. It should be noted that while the deflection screen 12 has been described and illustrated as having a convex conical shape, it is within the scope of the present invention for the deflection screen 12 to be substantially flat or have a concave conical shape.

Furthermore, in a preferred embodiment, the Bird Guard Device 10 of the present invention includes a stabilizing frame 30 mounted within the open end of the cowling 16 between the deflection screen 12 and the fan 18 to further support the deflection screen 12. Preferably, the stabilizing frame 30 has a first cross arm 32 substantially perpendicular to a second cross arm 34, thus shaped like a plus sign or a “t”. Additional parallel, perpendicular, and/or overlapping cross arms can be added if additional support for the deflection screen 12 is desired.

The mesh deflection screen 12 of the Bird Guard Device 10 of the present invention serves at least two purposes. First, the conical shape of the deflection screen 12 deflects birds away from the engine air intake. Secondly, the mesh of the deflection screen 12 is sized small enough to prevent typically dangerous birds such as geese from entering the jet engine 14 while having sufficient size to avoid interfering with air flow to the jet engine 14.

Using the Bird Guard Device 10 of the present invention is simple and straightforward. An airplane manufacturer or maintenance technician permanently installs the deflection screen 12 of the Bird Guard Device 10 at the front open end of each jet engine cowling 16 on an aircraft. As the aircraft takes off, climbs, levels out, descends, and lands, the Bird Guard Device 10 provides an effective screen that prevents birds from entering the engine. The deflection screen 12 is cleaned on a regular basis by maintenance crew members.

Being a permanently integral part of the engine cowling 16, the Bird Guard Device 10 of the present invention provides a practical solution for minimizing ingestion of birds into jet engine air intakes. The Bird Guard Device 10 provides increased safety for flight crews and passengers, eliminating potentially fatal consequences of bird strike damage. Durably constructed and securely installed with welded adherence to the internal walls of the engine cowling 16, the Bird Guard Device 10 will provide many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A bird guard device for protecting aircraft jet engines from being damaged from ingestion of birds during a bird strike, the jet engine having an outer cowling with an open front end, the bird guard device comprising:
a mesh deflection screen capable of being mounted within the open front end of the outer cowling;
wherein the deflection screen minimizes the chance of birds getting into the jet engine.

2. The bird guard device of claim 1 wherein the deflection screen is constructed from an aircraft grade aluminum or composite.

3. The bird guard device of claim 1 wherein the deflection screen completely covers the open front end of the outer cowling.

4. The bird guard device of claim 1 wherein the deflection screen only covers a portion of the open front end of the outer cowling.

5. The bird guard device of claim 1 wherein the deflection screen has a convex conical shape.

6. The bird guard device of claim 5 wherein an apex of the deflection screen is positioned beyond the open front end of the outer cowling.

7. The bird guard device of claim 1 and further comprising:
a stabilizing frame mounted within the open end behind the deflection screen.

8. The bird guard device of claim 7 wherein the stabilizing frame has a first cross arm substantially perpendicular to a second cross arm.

9. The bird guard device of claim 1 wherein the deflection screen is secured to the outer cowling by welding.

10. A method for protecting aircraft jet engines from being damaged from ingestion of birds during a bird strike, the jet engine having an outer cowling with an open front end, the method comprising:
mounting a mesh deflection screen within the open front end of the outer cowling;
deflecting birds off the deflection screen; and
minimizing the chance of birds getting into the jet engine.

11. A bird guard device for protecting aircraft jet engines from being damaged from ingestion of birds during a bird strike, the jet engine having an outer cowling with an open front end, the bird guard device comprising:
a mesh deflection screen capable of being mounted within the open front end of the outer cowling, the deflection screen having a convex conical shape, the deflection screen completely covering the open front end of the outer cowling;
wherein the deflection screen minimizes the chance of birds getting into the jet engine.

12. The bird guard device of claim 11 wherein the deflection screen is constructed from an aircraft grade aluminum or composite.

13. The bird guard device of claim 11 wherein an apex of the deflection screen is positioned beyond the open front end of the outer cowling.

14. The bird guard device of claim 11 and further comprising:
a stabilizing frame mounted within the open end of the outer cowling behind the deflection screen.

15. The bird guard device of claim 14 wherein the stabilizing frame has a first cross arm substantially perpendicular to a second cross arm.

16. The bird guard device of claim 11 wherein the deflection screen is secured to the outer cowling by welding.
